(19) United States
(12) Patent Application Publication
(10) Pub. No.: US 2026/0346646 A1
(43) Pub. Date: Nov. 5, 2026

(54) Flexible Airless Tire and Wheel Assembly

(71) Applicant: E Beach Wagon, LLC, Middletown, DE (US)

(72) Inventor: Michael F. Mogan, JR., Middletown, DE (US)

(73) Assignee: E Beach Wagon, LLC, Middletown, DE (US)

(21) Appl. No.: 19/663,366

(22) Filed: Apr. 30, 2026

Related U.S. Application Data
(60) Provisional application No. 63/798,121, filed on May 1, 2025.

(51) Int. Cl. B60C 7/12; B60B 25/00; B60B 25/22

(52) U.S. Cl. CPC B60C 7/121; B60B 25/006; B60B 25/22; B60C 2200/14

(57) ABSTRACT

A wheel assembly includes a wheel rim and a tire mounted on the wheel rim. The tire includes an outer side wall, an inner side wall, an inner surface connecting the outer side wall and the inner side, and an outer contact surface connecting the outer side wall and the inner side. The tire has a rim opening extending through a central longitudinal axis of the tire. Flexible foam is provided inside of a volume formed by the outer side wall, the inner side wall, the inner surface, and the outer contact surface.

### BACKGROUND OF THE INVENTION

The present invention relates generally to a tire and wheel assembly, and more particularly to a flexible, airless tire and wheel assembly suitable for use on soft and uneven terrain such as sand.

### DESCRIPTION OF THE RELATED ART

Vehicles and carts intended for use on soft or uneven terrain, such as sand, commonly utilize low-pressure pneumatic tires to distribute load over a larger surface area and reduce ground pressure. One example is the wheel described in U.S. Patent No. 6,279,631, which discloses a wide, low-pressure polyurethane tire designed to operate effectively on sand and similar surfaces.

While such low-pressure pneumatic tires can provide improved performance on soft terrain, they present several drawbacks. These tires typically operate at very low inflation pressures, for example in the range of approximately 2-3 psi, which is significantly lower than conventional tires. As a result, proper inflation requires specialized pressure gauges and user awareness, both of which are often lacking. Users frequently overinflate such tires, leading to deformation, reduced performance, and potential tire failure.

Additionally, pneumatic tires are inherently susceptible to air leakage due to valve failures, improper sealing, or punctures. In soft-terrain environments, where sharp objects may be present, punctures can render the tire inoperable and require repair or replacement, resulting in inconvenience and downtime.

Airless tire designs have been developed to eliminate the risk of puncture and the need for inflation. However, conventional airless tires are generally constructed from solid or semi-rigid materials and lack the flexibility required to conform to soft terrain. As a result, such airless designs do not adequately distribute load or provide sufficient flotation on sand, leading to poor performance compared to low-pressure pneumatic tires.

Accordingly, there remains a need for a tire and wheel assembly that combines the advantages of low-pressure pneumatic tires—namely flexibility and load distribution suitable for soft terrain—with the durability and maintenance-free characteristics of an airless design.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a wheel assembly that includes a wheel rim and a tire mounted on the wheel rim. The tire includes an outer side wall, an inner side wall, an inner surface connecting the outer side wall and the inner side wall, and an outer contact surface connecting the outer side wall and the inner side. The tire has a rim opening extending through a central longitudinal axis of the tire. Foam is provided inside of a volume formed by the outer side wall, the inner side wall, the outer contact surface, and the inner surface.

In another embodiment, the present invention is a wheel assembly comprising a wheel rim and a tire mounted on the wheel rim. The tire comprises an outer side wall, an inner side wall, an inner surface connecting the outer side wall and the inner side wall, and an outer contact surface connecting the outer side wall and the inner side. The tire has a rim opening extending through a central longitudinal axis of the tire and a fill port formed in the inner side wall, and vent holes in the inner side wall.

In still another embodiment, the present invention is a wheel assembly comprising a wheel rim having a rim body, a flange attached to an end of the rim body, and a central hub attached to the rim body. A tire is mounted on the wheel rim.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a front perspective view of a wheel assembly according to an exemplary embodiment of the present invention;

FIG. 1A is a rear perspective view of the wheel assembly of FIG. 1;

FIG. 1B is a perspective view of the tire only of the wheel assembly of FIG. 1A;

FIG. 2 is a side elevational view of a tire used with the wheel assembly of FIG. 1;

FIG. 3 is a sectional view of the tire of FIG. 2, taken through lines 3—3 of FIG. 2;

FIG. 4 is a perspective view of a rim used with the assembly of FIG. 1;

FIG. 5 is a side elevational view of the wheel assembly of FIG. 1, showing an unloaded height of the bottom of the tire rim above ground;

FIG. 6 is a front perspective view of an alternative embodiment of a rim; and

FIG. 7 is a perspective view of a tire used with the rim of FIG. 6.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase "in one embodiment" in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/- 10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word "about" or "approximately" preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

A wheel assembly 100 for an off-road vehicle, such as a wagon or other transport, is provided. Wheel assembly 100 includes a tire 110 mounted on a rim 150. Tire 110 is filled with foam and requires no air. Tire 110 can be punctured and be still operational.

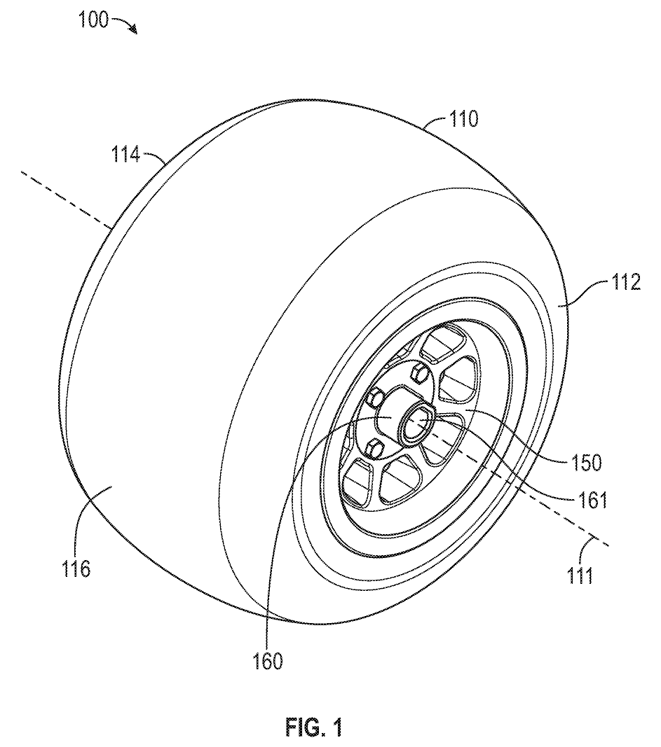

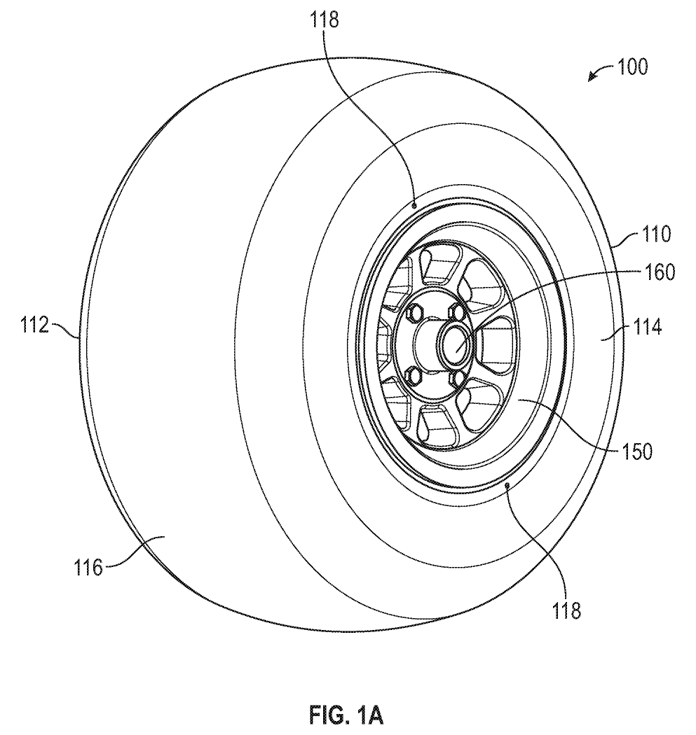

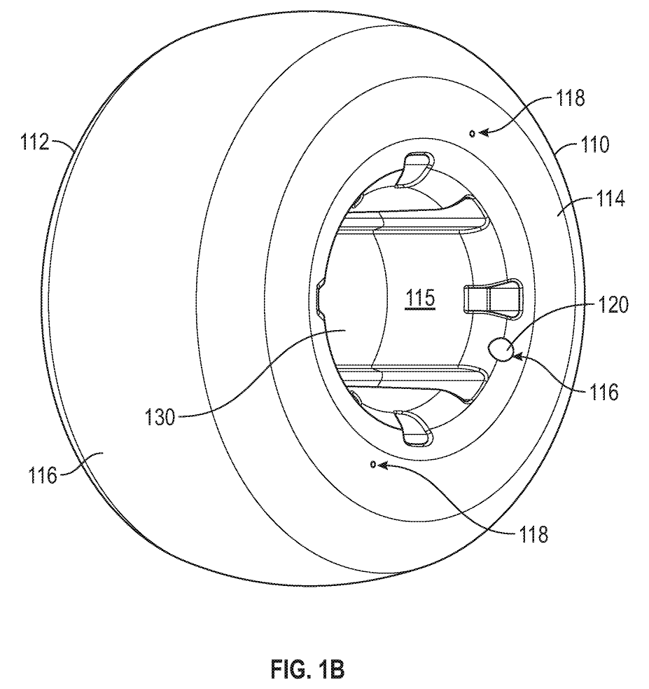

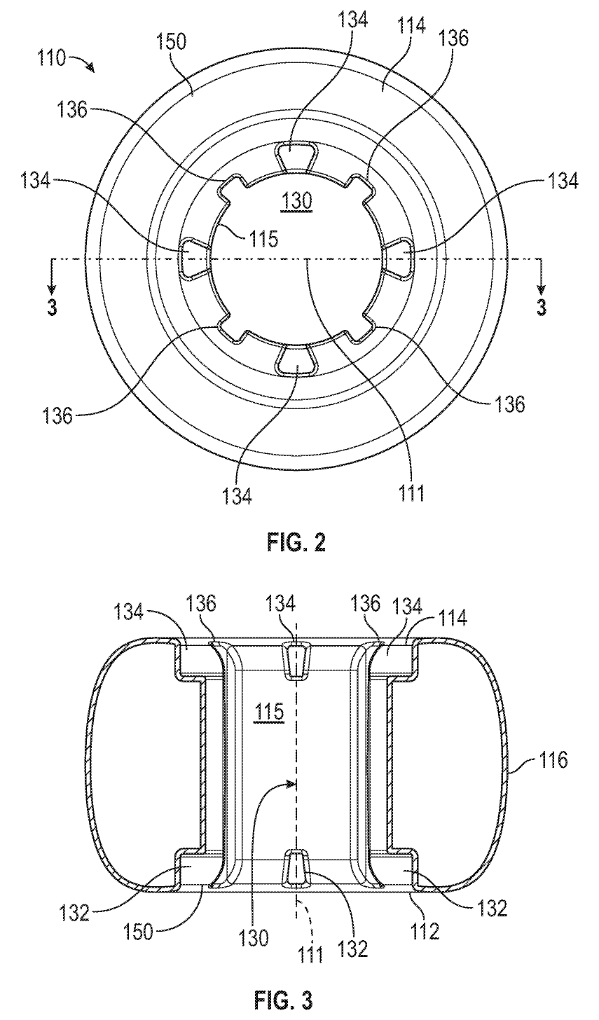

Referring to FIGS. 1-3, tire 110 includes an outer side wall 112 and an inner side wall 114, an inner surface 115 connecting outer side wall 112 and inner side wall 114, and an outer contact surface 116 connecting outer side wall 112 and inner side wall 114. Outer side wall 112, inner side wall 114, an inner surface 115 , and outer contact surface 116 form a volume in which the foam is provided.

For ease of description, outer side wall 112 faces the outside of a vehicle (not shown) on which tire 110 is mounted and inner side wall 114 faces toward the vehicle and another tire 110 on an opposite side of the vehicle. Outer contact surface 116 engages a road, a beach, or other surface on which tire 110 rotates.

Tire 110 can be constructed from a flexible polyurethane and has a thickness of between about 3 mm and about 4 mm. An exemplary tire can be the tire disclosed in U.S. Patent No. 6,279,631.

Tire 110 is generally annular in shape with a rim opening 130 formed by inner surface 115 extending along a central longitudinal axis 111 of tire 110. Tire 110 includes a fill port 116 in inner side wall 114 hidden behind rim 150. Inner side wall 114 is configured to face inside the vehicle (not shown), toward an opposing tire 110 on an opposite side of the vehicle. Fill port 116 is sized to allow a nozzle (not shown) to be inserted therein. The nozzle is attached to a foam source that injects an expanding flexible foam as the foam is discharged into the tire 110. An exemplary foam can be a flexible polyurethane foam, such as, for example, TC-296 FR, manufactured by BJB Materials, located in Tustin, CA.

Vent openings 118 are provided through inner side wall 114 to allow air to escape from inside tire 110 as the foam is introduced inside tire 110. After filling, the nozzle is removed from fill port 116 and a plug 120 is inserted into fill port 116, closing off fill port 116 so that no foam escapes out of fill port 116. Once tire 110 is filled with foam, tire 110 can be mounted onto a vehicle (not shown). Both the foam and the tire 110 together have sufficient flexibility so that tire 110 conforms to the contours of sand when wheels 100 are mounted on a vehicle (not shown) for traversing a sandy surface, such as a beach. This flexibility helps tire 110 stay on top of the sand and grip the sand while the drive axle of the vehicle turns them.

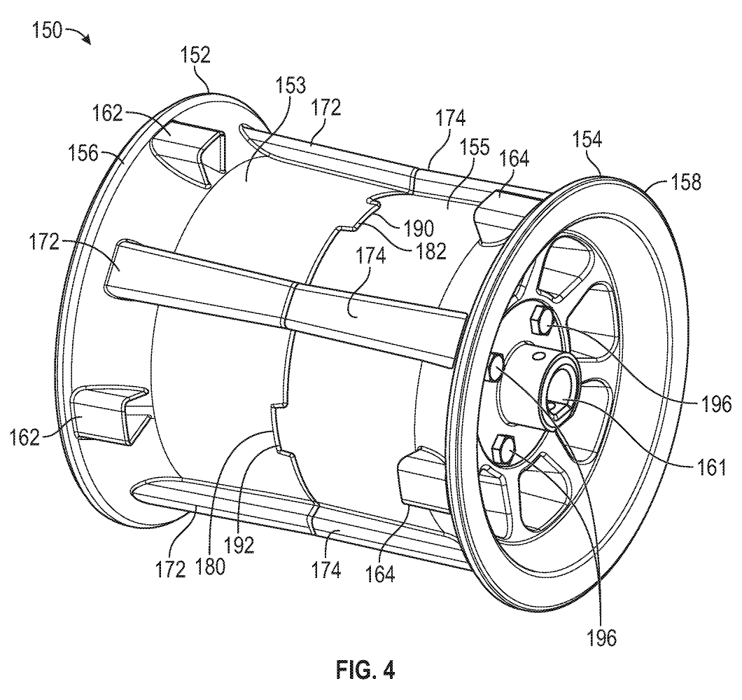

Rim opening 130 is sized for tire rim 150 (shown in FIG. 4) to securely fit into rim opening 130. Rim opening 130 includes a plurality of recesses 132, 134, 136 that are formed to accept complementary features extending from rim 150. The recesses 132, 134, 136 engage with rim 150 to ensure that tire 100 rotates with rim 150.

In an exemplary embodiment, four inner wall blind recesses 134 are formed 90 degrees apart from adjacent inner wall blind recesses 134 around rim opening 130. Inner wall blind recesses 134 start at inner side wall 114 and extend partially toward outer side wall 112. Similarly, four outer wall blind recesses 132 are formed 90 degrees apart from adjacent outer wall blind recesses 132 around rim opening 130. Outer wall blind recesses 132 start at outer side wall 112 and extend partially toward inner side wall 114.

In an exemplary embodiment, four through recesses 136 are formed 90 degrees apart from adjacent through recesses 136 and 45 degrees between adjacent blind recesses 132, 134. Through recesses 136 extend fully between inner side wall 114 and outer side wall 112.

Referring now to FIG. 4, rim 150 is shown in detail. Rim 150 includes two rim halves 152, 154, which can be identical and symmetrical such that inner rim half 152 can be joined with outer rim half 154 with tire 110 sandwiched in between rim halves 152, 154.

Inner rim half 152 includes an inner rim body 153 having a flange 156 and outer rim half 154 includes an outer rim body 155 having a flange 158. A central hub 160 is attached to each rim half 152, 154 inside inner rim body 153 and outer rim body 155. Rim half 152 includes a plurality of partial inner ribs 162 that extend from flange 156. Partial inner ribs 162 are sized and shaped to accommodate blind recesses 132 in tire 110. Four partial inner ribs 162 are formed 90 degrees apart from adjacent partial inner ribs 162 around rim 150. Similarly, rim half 154 includes a like plurality of partial outer ribs 164 that extend from flange 158. Partial outer ribs 164 are sized and shaped to accommodate blind recesses 132 in tire 112. Four partial outer ribs 164 are formed 90 degrees apart from adjacent partial outer ribs 164.

Inner rim half 152 also includes a plurality of full inner ribs 172 that extend from flange 156 to the end of inner rim half 152, while outer rim half 154 also includes a like plurality of full outer ribs 174 that extend from flange 158 to the end of outer rim half 154 such that, when rim halves 152, 154 are assembled together, inner ribs 172 and outer ribs 174 form single ribs that extend fully between flanges 156, 158.

Additionally, inner rim half 152 includes a pair of diametrically opposed cutouts 180 (only one cutout 180 shown in FIG. 4) and a pair of diametrically opposed nubs 182 (only one nub 182 shown in FIG. 4), evenly spaced between cutouts 180. Outer rim half 154 includes a complementary pair of diametrically opposed cutouts 190 (only one cutout 190 shown in FIG. 4) and a pair of diametrically opposed nubs 192 (only one nub 192 shown in FIG. 4), evenly spaced between cutouts 190 that engage with their respective cutouts 180 and nubs 182 on inner rim half 152 to secure rim halves 152, 154 to each other.

Ribs 162, 164, 172, 174 on hub 150 are used in conjunction with recesses 134, 134, 136 to prevent tire 110 from slipping relative to hub 150 when connected to a drive axle.

Roller bearings (not shown) are located inside central hub 160 to enhance rotatability of rim 150 around an axle (not shown). Bolts 196 are inserted through hub 160 on outer rim half 154 to hub 160 on inner rim half 152 to secure rim halves 152, 154 together.

A “D-shaped” hub 161, shown in FIG. 1, attaches rim 150 to a drive axle (not shown). Hub 161 can have varying sizes to accommodate different diameter axles.

To assemble wheel assembly 100, tire 110 is injected with the foam through fill port 116. After the foam cures, rim halves 152, 154 are positioned on either side of tire 110 and pushed toward each other so that inner ribs 172 and outer ribs 174 slide through recesses 136 and ribs 162, 164 slide into blind recesses 132, 134.

Alternatively, rim 150 can be first attached to tire 110, then tire 110 is injected with the foam.

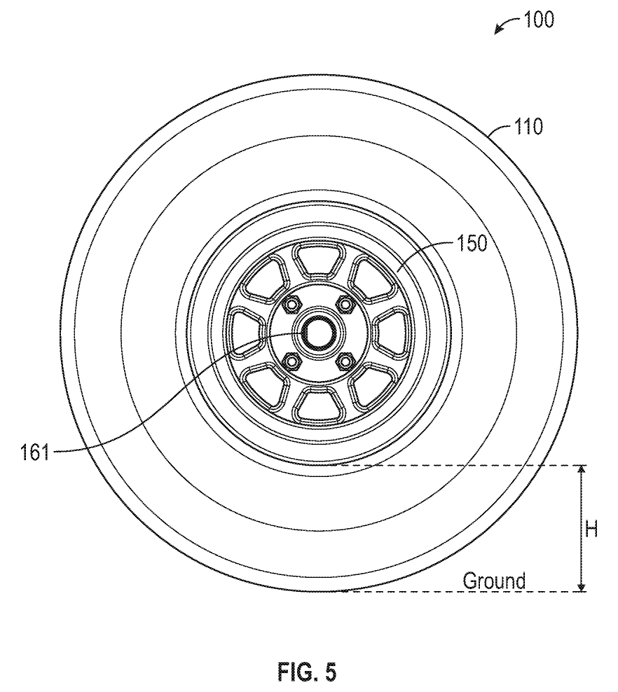

When no weight is applied to the wheel assembly 100, rim 150 is a distance “H” above ground level, as shown in FIG. 5. In an exemplary embodiment, when wheel assembly 100, along with three other wheel assemblies 100, are installed on a vehicle, such as a wagon, and when a weight, such as a load to be transported, is added to the wagon, and about 121 lbs. of force are applied to each wheel assembly 100, tire 110 is compressed, lowering the distance “H” to about 55% of the original, unloaded height.

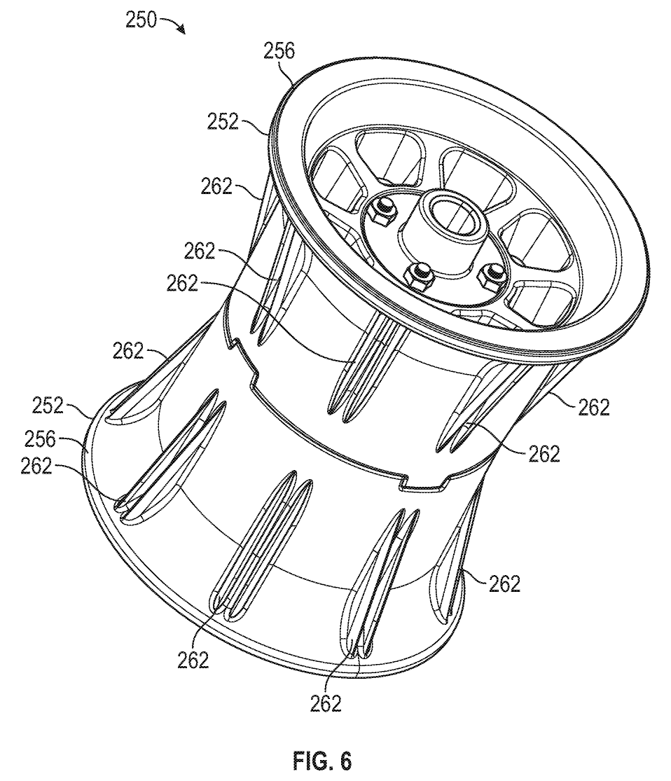

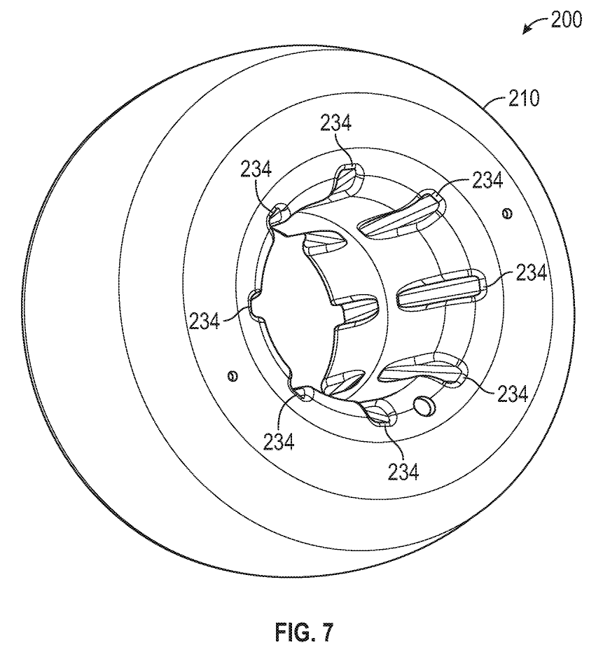

An alternative embodiment of a wheel assembly 200 with a tire 210 and a rim 250 is shown in FIGS. 6 and 7. Instead of ribs 162, 164 shown with rim halves 152 in FIG. 4, rim 250 includes ribs 262 with rim halves 252. Each rim half 252 includes a plurality of partial inner ribs 262 that extend from flange 256. Partial inner ribs 262 are sized and shaped to accommodate recesses 234 in tire 210. Eight partial inner ribs 262 are formed 45 degrees apart from adjacent partial inner ribs 262 around rim half 252.

It will be further understood that various changes in the details, materials, and arrangements of the parts which have been described and illustrated in order to explain the nature of this invention may be made by those skilled in the art without departing from the scope of the invention as expressed in the following claims.

I claim:

1. A wheel assembly comprising:
a wheel rim;
and
a tire mounted on the wheel rim, the tire comprising:
an outer side wall;
an inner side wall;
an inner surface connecting the outer side wall and the inner side;
an outer contact surface connecting the outer side wall and the inner side;
the tire having a rim opening extending through a central longitudinal axis of the tire; and
foam inside of a volume formed by the outer side wall, the inner side wall, the inner surface, and the outer contact surface.

2. The wheel assembly according to claim 1, wherein the tire is constructed from a flexible polyurethane.

3. The wheel assembly according to claim 1, further comprising a rim opening sized to accommodate the wheel rim.

4. The wheel assembly according to claim 3, further wherein the rim opening comprises a plurality of recesses sized to accept complementary features extending from the wheel rim.

5. A wheel assembly comprising:
a wheel rim;
and
a tire mounted on the wheel rim, the tire comprising:
an outer side wall;
an inner side wall;
an inner surface connecting the outer side wall and the inner side; and
an outer contact surface connecting the outer side wall and the inner side;
the tire having a rim opening extending through a central longitudinal axis of the tire; and
a fill port formed in the inner side wall.

6. The wheel assembly according to claim 5, wherein the fill port is sized to allow a nozzle to be inserted therein.

7. The wheel assembly according to claim 5, further comprising foam configured to be injected into the tire through the fill port.

8. The wheel assembly according to claim 5, further comprising a plug insertable into the fill port.

9. The wheel assembly according to claim 5, further comprising at least one vent opening provided through the inner side wall.

10. A wheel assembly comprising:
a wheel rim comprising:
a rim body;
a flange attached to an end of the rim body; and
a central hub attached to the rim body;
and
a tire mounted on the wheel rim.

11. The wheel assembly according to claim 10, wherein the rim comprises two rim halves.

12. The wheel assembly according to claim 11, wherein the rim halves are identical.

13. The wheel assembly according to claim 11, wherein the rim halves are symmetrical.

14. The wheel assembly according to claim 11, wherein the rim body comprises a plurality of ribs that extend from the flange.

15. The wheel assembly according to claim 14, wherein the rim body comprises a plurality of ribs that extend from the flange on a first of the rim halves and on a second of the rim halves.

16. The wheel assembly according to claim 15, wherein, when the first of the rim halves and the second of the rim halves are joined, at least some of the plurality of ribs form ribs extending from the flange on the first of the rim halves to the flange on the second of the rim halves.

17. The wheel assembly according to claim 11, wherein each of the rim halves includes a pair of diametrically opposed cutouts and a pair of diametrically opposed nubs, evenly spaced between the cutouts such that the cutouts on each of the rim halves engages with the nubs on the other of the rim halves to secure the rim halves to each other.

18. The wheel assembly according to claim 10, wherein the rim body comprises a plurality of ribs that extend from the flange.

19. The wheel assembly according to claim 18, wherein the tire comprises a plurality of recess formed therein, each of the plurality of recesses configured to engage one of the plurality of ribs.

20. The wheel assembly according to claim 10, wherein the central hub comprises a “D-shaped” end.
